(19) United States
(12) Patent Application Publication
(10) Pub. No.: US 2014/0146947 A1
(43) Pub. Date: May 29, 2014

(54) CHANNELING X-RAYS

(71) Applicant: Vanderbilt University, Nashville, TN (US)

(72) Inventors: Charles A. Brau, Nashville, TN (US); Bo Kyoung Choi, Nolensville, TN (US); Philippe Piot, Naperville, IL (US); Jonathan D. Jarvis, Nashville, TN (US); Marcus H. Mendenhall, Nashville, TN (US); William E. Gabella, Nashville, TN (US)

(21) Appl. No.: 14/091,542

(22) Filed: Nov. 27, 2013

Related U.S. Application Data
(60) Provisional application No. 61/730,670, filed on Nov. 28, 2012.

(51) Int. Cl. H01J 35/06

(52) U.S. Cl. CPC H01J 35/065
USPC 378/122

(57) ABSTRACT

Various examples are provided for channeling X-rays. In one example, among others, a system includes an electron gun including afield-emitting cathode capable of producing an electron beam with exquisitely small emittance, an accelerator capable of accelerating the emitted electrons to relativistic energies, and a focusing assembly capable of focusing the accelerated electrons into a focal spot on a diamond crystal to produce hard X-rays. In another example, a method includes producing an exquisitely small emittance of electrons from a field-emitting cathode, accelerating the emitted electrons to relativistic energies, focusing the accelerated electrons into a focal spot on a diamond crystal, and emitting hard X-rays from the diamond crystal.

### CROSS REFERENCE TO RELATED APPLICATIONS

This application claims priority to copending U.S. provisional application entitled “CHANNELING X-RAYS” having Ser. No. 61/730,670, filed Nov. 28, 2012, the entirety of which is hereby incorporated by reference.

### STATEMENT REGARDING FEDERALLY SPONSORED RESEARCH OR DEVELOPMENT

This invention was made with government support under agreement N66001-11-1-4196 awarded by DARPA and agreement N00014-07-1-1037 awarded by the ONR. The Government has certain rights in the invention.

### BACKGROUND

Beginning with Bragg's introduction of crystallography in 1912, Moseley's ordering of the chemical elements in 1913, and Compton's discovery of the momentum of a photon in 1923, much of what has been learned about physics, chemistry, and biology in the last century was discovered using X-rays. X-rays are now widely used as a tool in materials science and protein crystallography. In medicine, too, X-rays have progressed from Roentgen's first shadow images of the bones in his hand to 3-D computerized tomography.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a graphical representation of channeling radiation in a crystal in accordance with various embodiments of the present disclosure.

FIG. 2 is a plot of an example of a channeling radiation spectrum for transitions in a plane of diamond crystal in accordance with various embodiments of the present disclosure.

FIG. 3 is a plot of an example of photon energy with respect to electron energy for the diamond crystal of FIG. 2 in accordance with various embodiments of the present disclosure.

FIG. 4 is a graphical representation of an example of a system that is a channeling radiation source of hard X-rays in accordance with various embodiments of the present disclosure.

FIG. 5(a) illustrates electron trajectories from a gated field-emitting tip of the system of FIG. 4 in accordance with various embodiments of the present disclosure.

FIG. 5(b) is an image or an example of a diamond cathode tip and self-aligned gate in accordance with various embodiments of the present disclosure.

FIG. 6 is a graphical representation of an example of an RF electron gun of FIG. 4 in accordance with various embodiments of the present disclosure.

FIG. 7 is a plot illustrating an example of a two frequency gating for a field-emitting cathode in accordance with various embodiments of the present disclosure.

FIGS. 8A-8G illustrate an example for fabricating an ungated diamond field emission array in accordance with various embodiments of the present disclosure.

FIGS. 9A-9F are images illustrating the fabrication of an ungated diamond field emission array in FIGS. 8A-8G in accordance with various embodiments of the present disclosure.

FIGS. 10A-10D and 12A-12D illustrate examples for fabricating a gated diamond field emission array in accordance with various embodiments of the present disclosure.

FIGS. 11A-11B and 13 are images of examples of diamond cathode tips with a self-aligned gate fabricated in FIGS. 10A-10D and 12A-12D, respectively, in accordance with various embodiments of the present disclosure.

### DETAILED DESCRIPTION

Disclosed herein are various embodiments related to channeling radiation as a source of hard X-rays. Reference will now be made in detail to the description of the embodiments as illustrated in the drawings, wherein like reference numbers indicate like parts throughout the several views.

Roentgen's discovery of X-rays in 1895 opened up a new window on the physical world. Paralleling and enabling the advances in X-ray applications has been the continued development of X-ray sources, which have moved from Roentgen's primitive Crookes tube to the recent development of the X-ray free-electron laser (FEL) at SLAC. However, the hard X-ray FEL is large and expensive, and an experiment that requires a day on the machine costs about $1 million just for the machine time. For this reason, most X-ray needs are satisfied by a variety of “conventional” sources and a growing number of unconventional sources that can be dispersed among the labs and offices where the X-rays are used.

A figure of merit can be used to compare the various X-ray sources. Although the total number of X-ray photons is a useful measure for many applications such as, e.g., sterilizing food, newer applications in medical imaging and physics research depend on the coherence of the X-rays. This is better represented by the spectral brilliance (BO of the X-ray beam, which is defined as the number of photons per second, per unit area, per unit solid angle, per unit relative bandwidth:

$${B}_{v} = \frac{{vd}^{4} n}{d A d Ω d v d t}$$

where n is the number of photons, lithe frequency, t the time, A the area, and Ω the solid angle of the beam.

The importance of the spectral brilliance may be illustrated by focusing an X-ray beam on a specimen using a zone plate. Compared to the flux at the zone plate, the flux (photons per unit area per unit time) at the focus is increased by the factor of 4N², where N is the number of zones. However, the number of zones cannot usefully exceed the reciprocal bandwidth of the X-ray beam or the coherence of the interfering waves is lost. Putting this together with some simple geometric arguments, the flux at the focus is on the order of Φ˜λBᵥ/2f, where is the wavelength of the X-rays and f is the focal length of the zone plate. This depends only on the spectral brilliance. In a modern synchrotron with a spectral brilliance on the order of 10¹⁹ photons/s/mm²/mrad²/0.1% BW at a wavelength of 1 nm (1.2 keV), and a focal length of 1 cm, the photon flux at the focus is 10²⁷ photons/m²-s. For a dipole-allowed, lifetime-broadened transition, the cross-section for x-rays to interact with an atom is on the order of λ²/4˜10⁻¹⁹ m², and the relative line width is on the order of 4r_{c}/3λ˜1/300, where r_{c} is the classical electron radius. Even allowing for the fact that the radiation bandwidth, 1/N˜1/100, where N is the number of undulator periods, is a bit larger than the line width, the rate of excitation of each atom in the sample is 10⁷/s! This makes it possible to detect a single atom in fluorescence.

Conventional X-ray sources are the result of improvements to the original Crookes tube used by Roentgen. Electrons are accelerated electrostatically from about 10 kV to about 100 kV and impact a metal target. The X-radiation consists of sharp lines (e.g., a few eV wide) from inner-shell transitions in the atoms of an anode plus a broad Bremsstrahlung background. The principle limitation in conventional X-ray tubes is heating of the anode by the electron impacts. To address this problem, high-power tubes use a rotating anode, and in some cases liquid-metal jets have been used. The spectral brilliance from a conventional high-power tube can be as high as 10¹⁰ photons/s/mm²/mrad²/0.1% BW at the characteristic lines of the anode, such as 9 keV for Cu Kα and 20 keV for Mo Kα radiation. The Bremsstrahlung background is broad and accounts for most of the photons that are radiated, but the spectral brilliance of the Bremsstrahlung is about three orders of magnitude smaller.

Synchrotron radiation sources presently offer the highest average spectral brilliance in the X-ray regime. Broadband radiation is generated in the bending magnets of an electron storage ring. Spectral brilliance as high as 10¹⁵ photons/s/mm²/mrad²/0.1% BW in the keV range has been obtained this way at the Advanced Light Source at Lawrence Berkeley National Laboratory. The critical frequency, above which the radiation begins to fall off exponentially, is ω_{crit}=3γ²ω_{NRC}, where γ is the Lorentz parameter of the electrons, ω_{NRC}=eB/m˜10⁴ eV is the nonrelativistic cyclotron frequency for the magnetic field B (which may typically be about 1 T) in the bending magnet, e is the electron charge, and is the electron mass. Electrons in the 10 GeV range are needed to generate hard X-rays. To improve the spectral brilliance, static undulator magnets are used to generate narrow-band X-rays at a wavelength of λₓ˜λᵤ/γ², where λᵤ is the period of the undulator. The properties of magnet materials optimize λᵤ around a few centimeters, so production of hard X-rays needs electrons in the 10 GeV range. Average spectral brightness in excess of 10¹⁹ photons/s/mm²/mrad²/0.1% BW in the 10 keV range has been achieved this way at the Advanced Photon Source at Argonne National Laboratory.

To avoid the GeV electrons needed for conventional undulators, Compton backscatter of laser photons (sometimes referred to as laser undulators) from a relativistic electron beam can be used. The X-ray photon energy is then hvₓ=4γ²hv_{L}˜5γ² eV for a 1 μm laser (photon energy hv_{L}˜1.2 eV), which allows hard X-rays to be generated using 10-50 MeV electrons. The linewidth of the X-rays can be determined by the emittance of the electron beam, which causes the focused electrons to cross the axis at an angle. When the laser and the electron beam are optimally focused in the interaction region, the average spectral brilliance is found to be:

$${\overline{B}}_{v} \sim \frac{{πσ}_{T}}{2 {hec}^{2}} \frac{{hv}_{x}}{{hv}_{L}} \frac{{τ}_{e}}{{τ}_{L} + {τ}_{e}} {\hat{B}}_{N} {\overline{P}}_{L}$$

where σ_{T} is the Thomson cross-section, h is Planck's constant, c is the speed of light, τₑ is the electron pulse length, τ_{L} is the laser pulse length (which may typically be about the same as the electron pulse length), \hat{B}_{N} is the peak normalized brightness of the electron beam, and P̅_{L} is the average power of the laser.

The spectral brilliance will be reduced if the energy spread of the electrons is too large or if the intensity of the laser is high enough to shift the frequency of the backscattered photons. Although the above expression suggests that the spectral brilliance is independent of the electron-beam current, this is true only down to the current at which the broadening of the X-rays is dominated by the energy spread of the electron beam or the laser broadening, rather than the emittance. The only parameters in this expression are the peak brightness of the electron beam and the average laser power. For RF photoelectric injectors, the brightness is on the order of 10¹³ A/m²-steradian, so to achieve a spectral brilliance of 10¹² photons/s/mm²/mrad²/0.1% BW in the 10 keV range, which is an advance of two orders of magnitude beyond a conventional source, requires a laser average power of 1 kW. This might be achieved by recirculating a laser beam of lower power.

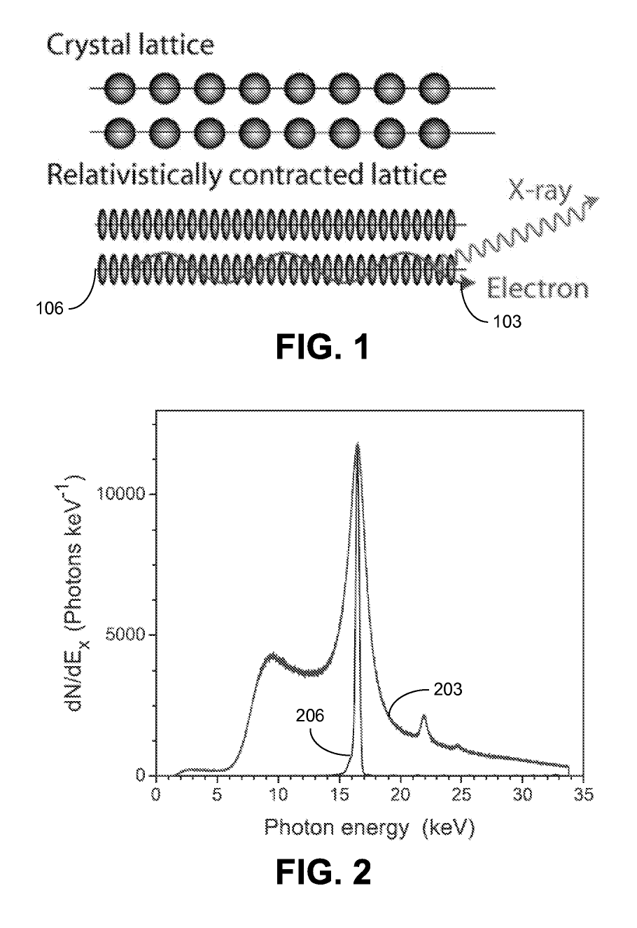

Channeling radiation offers an alternative to Compton backscatter. In a crystal, the ions in each crystal plane form a sheet of positive charge. Referring to FIG. 1, when a relativistic electron 103 travels through the crystal parallel to the crystal plane 106, Lorentz contraction increases the charge density by the factor of γ and the electron 103 oscillates about the crystal plane 106 in quantum states normal to the plane. Radiation from transitions between the quantum states is called channeling radiation. The transverse forces experienced by an electron traveling along a crystal plane are comparable to those in a 10⁴ T magnetic undulator or a 1 TW laser undulator focused to a 10 μm spot. The equivalent “undulation period” is on the order of 0.1 μm. The coherence length of the crystal “undulations” is limited by scattering to the order of about 1 μm, so the number of “undulation periods” in channeling radiation is on the order of 10. The photon yield is more than 10 photons per electron in the gamma ray region, but on the order of 10⁻⁴ photons per electron in the X-ray region. The channeling radiation peaks are typically an order of magnitude above the Bremsstrahlung background. When compared with a conventional undulator, the advantages of a channeling radiation source become clear. Channeling radiation requires only a 40 MeV electron beam, rather than a 10 GeV electron beam to reach the hard X-ray region. And when compared with a laser undulator, a channeling radiation source can include a small diamond chip rather than a complex laser system circulating a kilowatt of laser power.

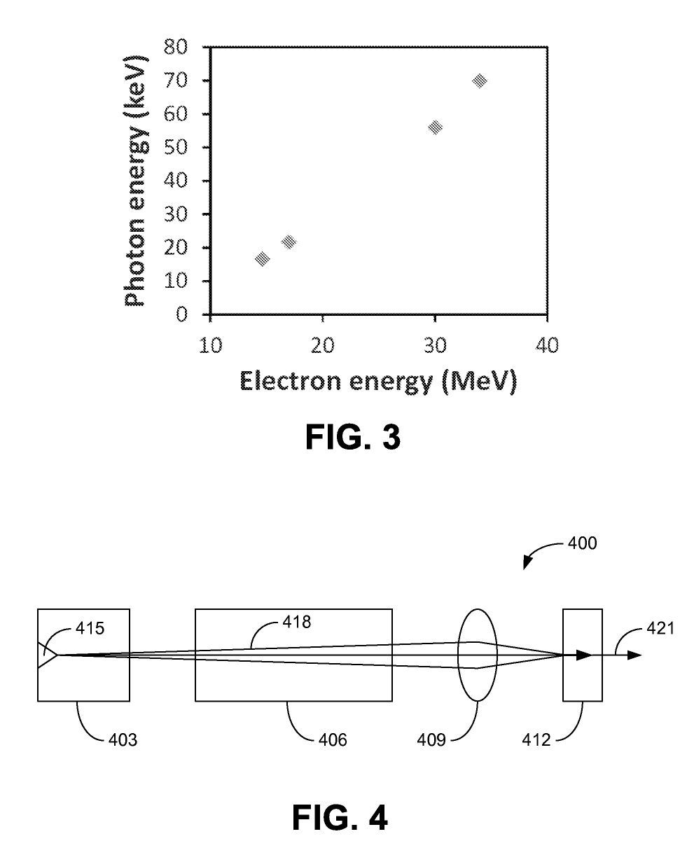

Referring now to FIG. 2, shown is an example of a typical channeling radiation spectrum for transitions in a plane of diamond crystal at an electron energy of 14.6 MeV. Curve 203 is the natural spectrum while curve 206 is monochromatized by Bragg reflection to remove the wings of the CR line and the Bremsstrahlung background. The radiation is forward directed in a cone of angle 1/γ, and Doppler shifted by the factor 2γ. Including the Lorentz contraction of the crystal lattice, the photo energy scales roughly γ^{1.7}, and spans the X-ray and gamma-ray regions. For the 1→0 transition in (110) diamond, the photon energy may be tuned from about 10 keV to about 80 keV by varying the electron energy from about 10 MeV to about 40 MeV, as illustrated in FIG. 3. For a 30-MeV electron incident on a 42.5-micron-thick diamond crystal, the yield on the 1→0 transition corresponds to about 0.028 photons/steradian-keV in a line 3 keV wide centered near 56 keV. In conventional units, this corresponds to 10⁻⁹ photons/mrad²/0.1% BW per electron.

The spectral brilliance of the x-radiation depends on how tightly the electron beam can be focused, and this depends on the emittance and the convergence angle of the beam. A high-intensity channeling radiation source may be implemented using a high-brightness electron beam incident on a diamond crystal. Diamond is the best material for this application owing to its high thermal conductivity and radiation resistance. Using a gridded thermionic gun, the normalized emittance of the beam after aperturing can be 10 μm rms at a peak current of 30 A, which corresponds to a peak brightness on the order of 10⁹ A/m²-sterad. With the beam focused to a mm-size spot on the diamond crystal, as many as 10¹⁰-10¹¹ photons/s can be obtained in a 10% bandwidth, which corresponds roughly to an average spectral brilliance on the order of 10⁶ photons/s/mm²/mrad²/0.1% BW.

Referring to FIG. 4, shown is a graphical representation of a system that is a source of hard X-rays. The system 400 of FIG. 4 includes an electron gun 403, an accelerator 406, a focusing assembly 409, and a crystal 412. In the example of FIG. 4, the electron gun 403 includes a single field-emitting cathode (or tip) 415 as the current source for the system 400. The field-emitting tip 415, which may be gated or ungated, produces a beam of electrons with an exquisitely small emittance (on the order of a few nm). For example, the emittance may be less than 2 nm. The beam of emitted electrons 418 is accelerated by the accelerator 406 to an energy level sufficient to create the hard X-rays 421. The electron beam 418 is focused by the focusing assembly 409 at the critical angle for channeling radiation in the crystal 412 (e.g., a diamond crystal) to generate the hard X-rays 421. The acceleration and focusing are such that the electron beam 418 is concentrated on a very small area of the crystal 412.

The field-emitting tip 415 may be, e.g., a pyramid including a nanodiamond layer. A diamond field-emitting tip may be formed by deposition of a nanodiamond layer in a pyramidal mold. The interior of the pyramid defined by the nanodiamond layer may then be filled with microdiamond or other material. A gated field-emitting tip 415 may be formed using either a volcano process or a SOI process. Other embodiments may include field-emitting tips 415 including, e.g., carbon nanotubes (which may be formed in pyramidal or non-pyramidal shapes), metallic needles (which may be formed using etching or photolithography), or silicon pyramids.

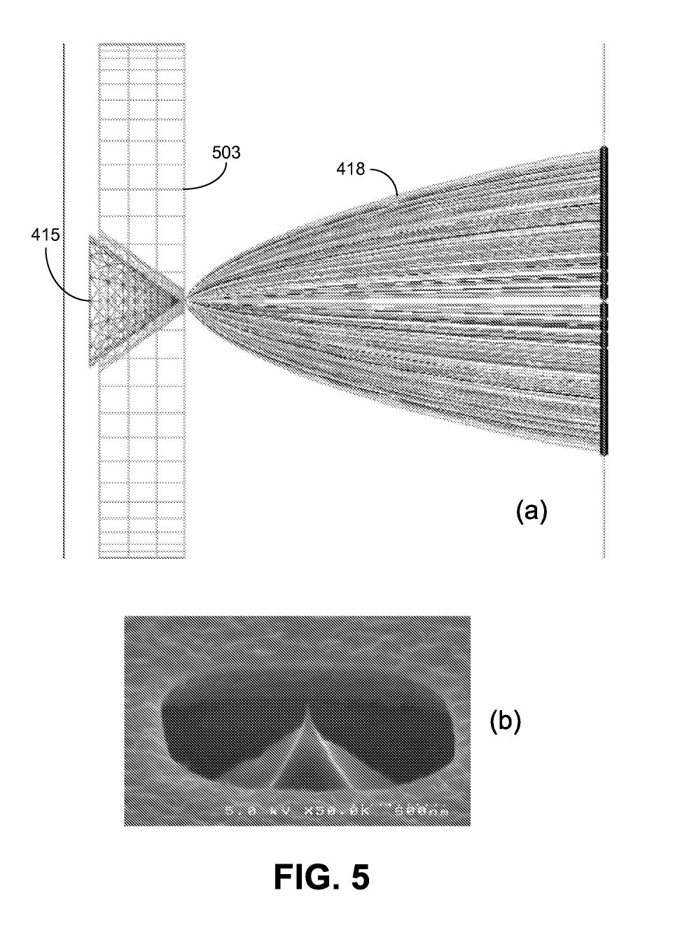

To estimate the emittance from a single field-emitting tip 415, the code CPO was used to simulate the emission from a diamond field emitter with a gated structure 503, as shown in FIG. 5(a). A second gate may be used as a focusing electrode. The simulations yielded a normalized emittance of 1.3 nm, which is an improvement of three orders of magnitude over a thermionic gun, FIG. 5(b) is an image of a diamond cathode tip and self-aligned gate including a monolithic structure (formed using the SOI process). The tip radius is about 6 nm. In experiments using a diamond cathode tip, an average current of more than 10 μA was observed from the single field-emitting tip 415 with a brightness approaching the quantum limit. The current was limited by damage to the anode, which was in close proximity. By using a single tip 415, the transverse brightness of the electron beam may be improved by as much as six orders of magnitude, compared with an array of Ups, a photocathode, or a thermionic cathode, with a corresponding improvement of the spectral brilliance of the X-ray beam. The absolute emittance of the beam 418 from a single tip 415, extrapolated to 30 MeV, is 40 μm. Focusing the electron beam 418 at the critical angle for channeling radiation in a diamond crystal 412 (e.g., about 1 mrad), can produce a spot diameter of 40 nm. The spectral brilliance of the X-ray beam 421 is then 10¹² photons/s/mm²/mrad²/0.1% BW at an average current of 200 nA.

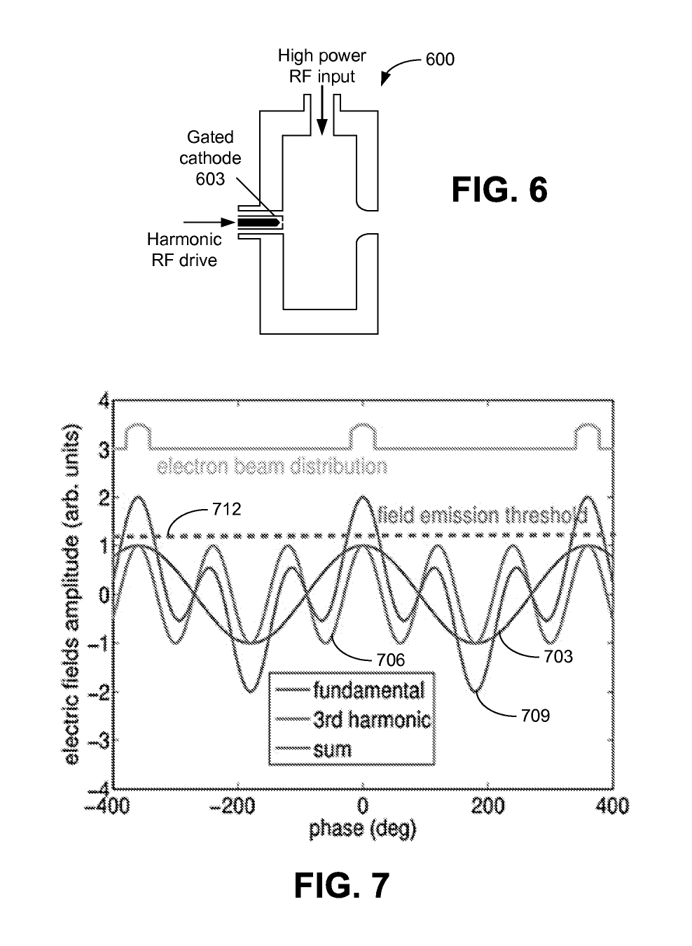

As illustrated in FIG. 4, the electron beam 418 is accelerated to relativistic energies to create hard X-rays 421. The acceleration can be staged. First, the RF electron gun 403 bunches and accelerates the electron beam 418 to energies (e.g., from about 1 Mev to about 5 MeV) sufficient for the electron beam 418 to become relativistic. Referring to FIG. 6, shown is a graphical representation of a gated field-emitting cathode 603 in an RF gun 600. By biasing the gate electrode 603 with low-level RF in a combination of the first and third harmonics of the RF fundamental, the emission can be restricted to about 12 degrees centered at the optimum phase. The relativistic beam may then be accelerated to its final energy by, e.g., a conventional linear particle accelerator (linac). The RF gun would play a important role in bunching the field emitted beam 418 while preserving the transverse beam quality. Another implementation may incorporate an RF gun cavity resonating at two harmonic frequencies. The phases and amplitudes of the respective electromagnetic fields could then be selected to gate the field emission as illustrated in FIG. 7 without the need for a microfabricated gate electrode. By combining a fundamental harmonic 703 and a third harmonic 706, the sum 709 of the two exceeds a field emission threshold 712 on a periodic basis. Such a technique could provide field emitted bunches with durations much shorter than the wavelength of the accelerating (or fundamental) mode. The exquisite emittances produced by the field emitter tip 415 may be preserved after acceleration and manipulation. Chromatic aberrations due to energy spread in the beam 418, emittance dilution due to nonlinearity in the RF fields, geometric aberrations in the electron beam transport lines, and collective effects may be mitigated. Since such an electron beam source represents an order-of-magnitude increase in electron beam quality, other effects which to date have been unnoticed may also become important. For example, the extent to which Coulomb collisions at low energies (Boersch effect) will contribute to phase space dilution may be a concern.

In some embodiments, an array of field-emitting cathode tips may be utilized in the RF gun. The field-emitting tips may be gated individually or as a group. For example, gating of the field-emitting tips may be staggered to allow a series of emissions to be accelerated and focused on a diamond crystal to produce hard X-rays. In other implementations, at least a portion of the array of field-emitting tips may be gated together to increase the emission from the electron gun. The beams from each tip would be focused on a corresponding focal spot (e.g., about 20 nm to about 100 nm in diameter) on a diamond crystal. Image processing may then be used to separate an acquired image into portions associated with each field-emitting tip. The separated portions may then be recombined to produce a final image.

An X-ray source based on an RF accelerator could be made compact by using X-band linac technology. Acceleration gradients in excess of 100 MV/m have now been achieved, so that a 40-MeV accelerator—capable of producing 85-keV CR photons—may be achieved with 40 cm of acceleration. Higher-frequency accelerators fabricated lithographically may also make it possible to place the entire accelerator and X-ray source on a single chip.

Because the X-rays are produced by the interaction of the electron beam 418 with the crystal 412, the maximum current of the electron beam 418 is limited by heating of, and radiation damage to, the crystal 412. Measurements and computations show that for diamond at room temperature the effects of heating are acceptable up to a few mA of beam current, so this will not be a limitation even for continuous wave (cw) operation. Measurements show that radiation damage becomes significant above a total beam fluence on the order of a few C per square centimeter. Thus, a 40 nm focal spot is destroyed in about 100 ms. Movement of the crystal 412 can litigate some of this effect. By moving the crystal 412 at about 0.1 mm/s, the crystal is destroyed at a rate of about 0.01 square millimeters per hour.

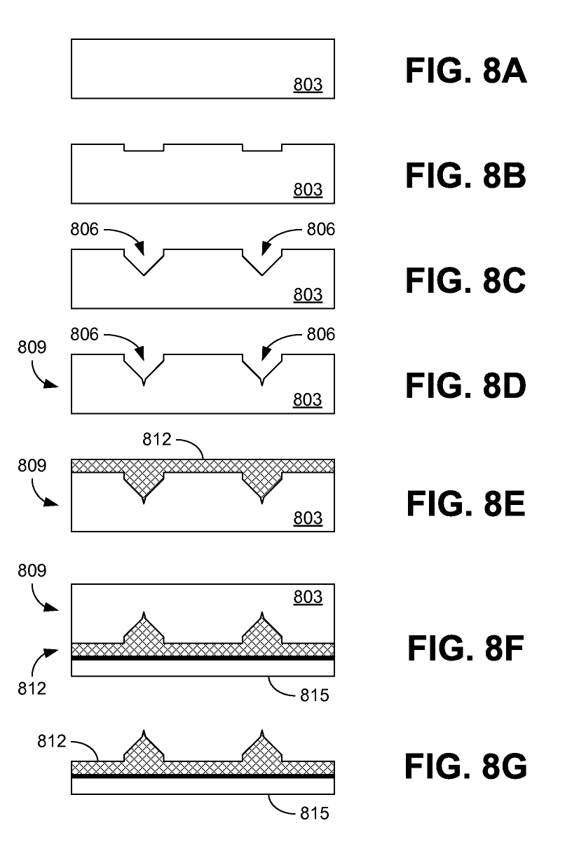

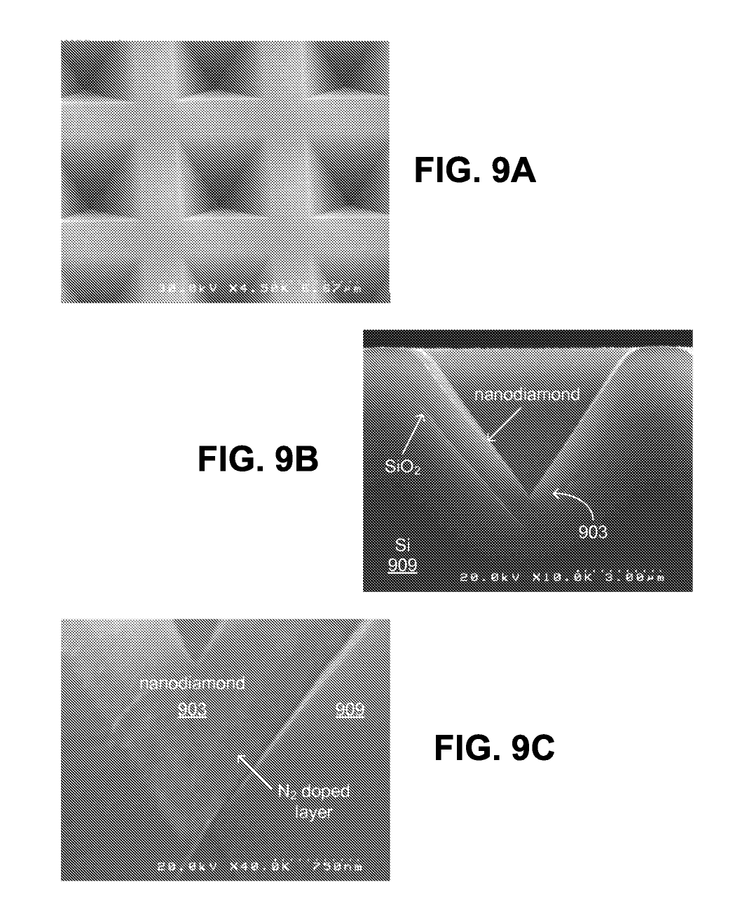

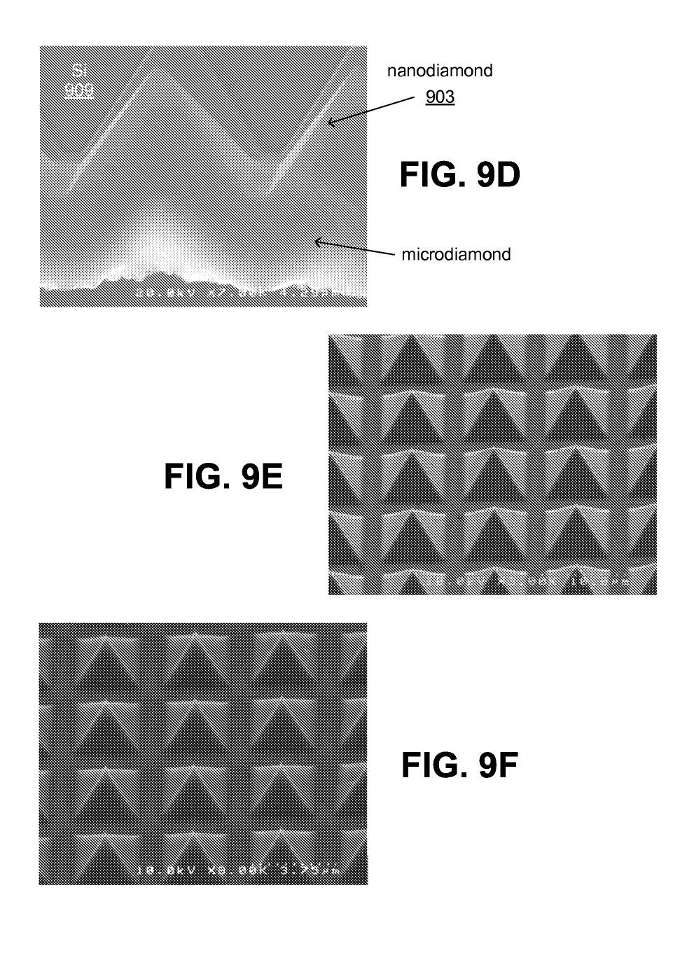

Diamond field emission cathodes offer a rugged cathode design with individual emitters having exquisitely small emittance. An array of field-emitting cathode tips may be implemented with diamond field emission cathodes. Ungated diamond field emission arrays can be fabricated using, e.g., a pyramidal mold or other appropriate cathode shape. FIGS. 8A-8G illustrate an example for fabricating an ungated diamond field emission array. In FIG. 8A, thermal oxidation of a silicon (Si) substrate 803 is carried out using, e.g., wet oxidation at 1100° C. Oxide patterning (FIG. 8B) and anisotropic etching with, e.g., KOH etching at 60° C. (FIG. 8C) are used to form an array of pyramidal cavities 806 in the Si substrate 803. For example, a 300 nm silicon dioxide (SiO₂) layer can be used for up to 5 μm base pyramidal molds. In other embodiments, a 100 nm chromium (Cr) layer may be used for up to 5 μm base pyramidal molds. At FIG. 8D, tip mold sharpening oxidation is performed with, e.g., wet oxidation at 1100° C. to for the mold 809. FIG. 9A is an image of an example of a final reverse pyramidal mold 809.

Diamond deposition is used to form the diamond field emission array 812 in FIG. 8E. A first layer of nanodiamonds is deposited on the mold 809. FIG. 9B is an image of a cross-section of a first layer 903 of nanodiamonds disposed on a Si mold 909 including a SiO₂ layer. In some implementations, at least a portion of the first layer 903 may be doped. For instance, FIG. 9C is an image of a cross-section of the first layer 903 of nanodiamonds including a N₂ doped layer. The interior of the cathode may be filled by depositing microdiamonds. A microwave plasma CVD system can provide reliable diamond growth on the mold. For example, the diamond field emission array 812 may be formed using MPCVD at 0.7 kW (1 μm thick) and MPCVD at 1.3 kW (about 4 μm thick). FIG. 9D is an image of a cross-section of a diamond field emission array with a nanodiamond layer filled with microdiamonds.

In FIG. 8F, the diamond field emission array 812 is attached to a backing substrate 815 by braizing. For example, vacuum brazing using TiCuAg or TiCuSiI alloy may be used to attach the diamond field emission array 812 to a Mo backing substrate 815 at about 800° C. The Si mold 809 and oxide can then be removed in FIG. 8G using, e.g., KOH etching at 60° C. and a BOE oxide etch cleaning process. Bias-enhanced nucleation can improve the surface structure of the nanodiamond. Larger uniform arrays with improved yield may be produced in this way. FIGS. 9E and 9F are images of diamond field emission arrays with a 7 μm pitch and a 4 μm pitch, respectively. The thin diamond layer allows brazing of the large arrays to the backing substrate 815 (FIG. 8G).

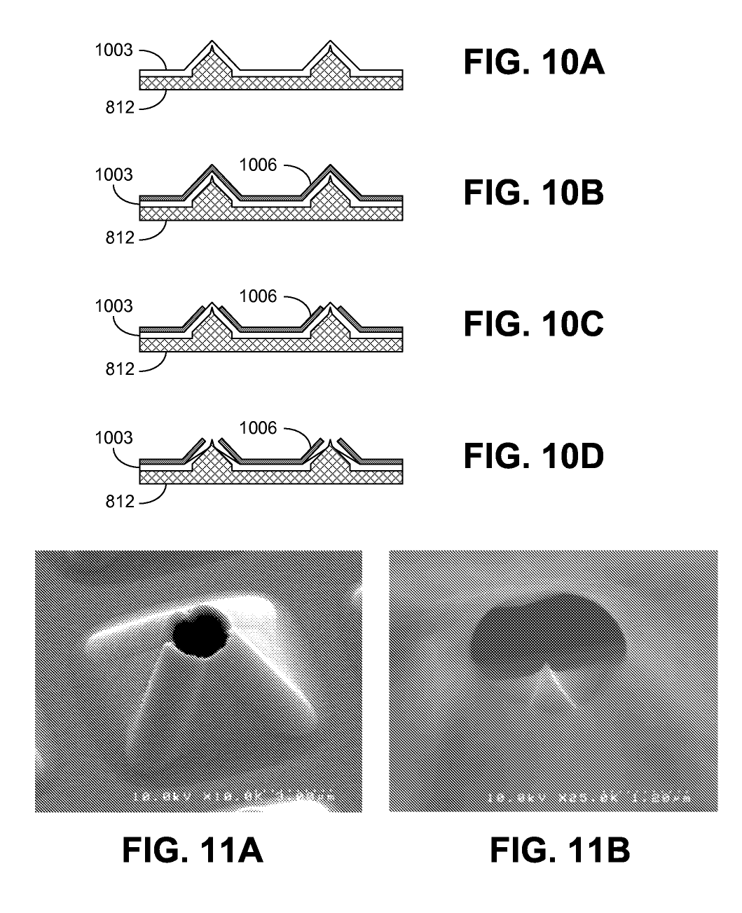

Gated diamond field emission arrays may be fabricated from the ungated diamond field emission arrays in two ways: a volcano process or a SOI process. FIGS. 10A-10D illustrate an example for fabricating a gated diamond field emission array with the volcano process. Beginning with FIG. 10A, a SiO₂ layer 1003 is used as a preserving mold over the diamond field emission array 812. A niobium (Nb) or other metallic layer 1006 can be disposed on the SiO₂ layer 1003 through evaporation in FIG. 10B. A portion of the metallic layer 1006 is etched back in FIG. 10C using, e.g., reactive ion etching (RIE) or focused ion beam (FIB) milling or lithographic techniques. The cathode tips of the diamond field emission array 812 may then be exposed in FIG. 10D with wet etching using, e.g., BOE. In this way, a gated field emitting tip is formed by the opening in the metallic layer 1006. FIG. 11A is an image of a diamond cathode tip with a self-aligned gate formed using the volcano process with RIE and FIG. 11B shows a tip formed using FIB milling.

Gated diamond field emission arrays may be fabricated from the ungated diamond field emission arrays in two ways: a volcano process or a SOI process. FIGS. 10A-10D illustrate an example for fabricating a gated diamond field emission array with the volcano process. Beginning with FIG. 10A, a SiO₂ layer 1003 is used as a preserving mold over the diamond field emission array 812. A niobium (Nb) layer 1006 can be disposed on the SiO₂ layer 1003 through evaporation in FIG. 10B. A portion of the Nb layer 1006 is etched back in FIG. 10C using, e.g., reactive ion etching (RIE). The cathode tips of the diamond field emission array 812 may then be exposed in FIG. 10D with wet etching using, e.g., BOE. In this way, a gated field emitting tip is formed by the opening in the Nb layer 1006. FIG. 11 is an image of a diamond cathode tip with a self-aligned gate formed using the volcano process.

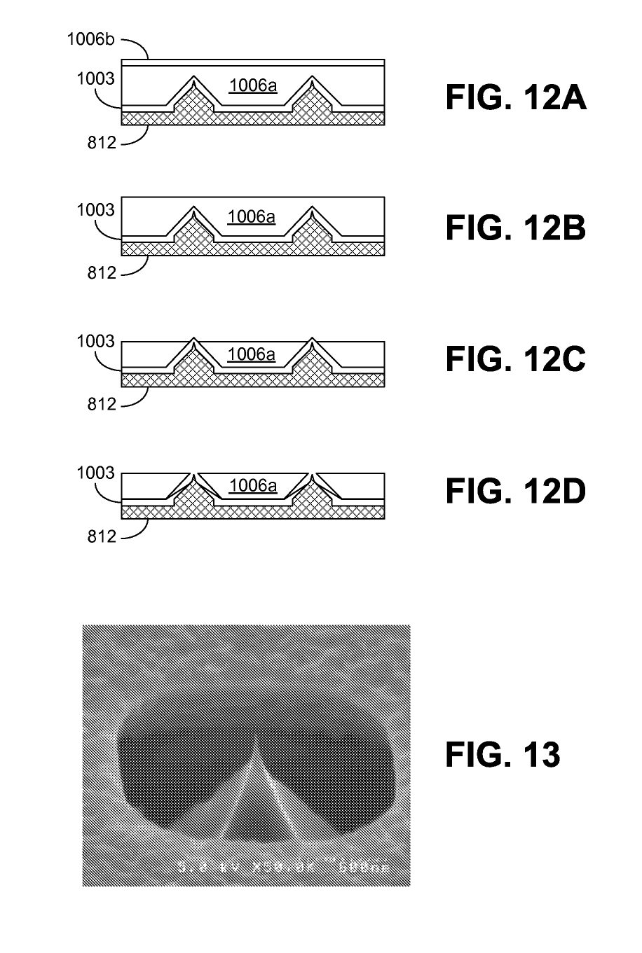

FIGS. 12A-12D illustrate an example for fabricating a gated diamond field emission array with the SOI process. Beginning with FIG. 12A, a SiO₂ layer 1003 is used as a preserving layer over the diamond field emission array 812 that is buried under Si 1006a and a second preserving SiO₂ layer 1006b. At least a portion of the SiO₂ layer 1006b is removed in FIG. 12B by etching. The Si 1006a is then thinned in FIG. 12C to expose the SiO₂ layer 1003 over the cathode tips of the diamond field emission array 812. The cathode tips may then be exposed in FIG. 12D with wet etching using, e.g., BOE. In this way, a gated field emitting tip is formed by the opening of the Si 1006a. FIG. 13 is an image of a diamond cathode tip with a self-aligned gate formed using the SOI process. The diamond cathode tip and self-aligned gate comprise a monolithic structure with a Up radius of about 6 nm.

Channeling radiation can be a source of extremely high spectral brilliance X-rays. The diamond field emission arrays have exhibited excellent uniformity after hitting with greater than 1 μA/tip. Individual diamond field emitters provide electron beams with exquisite brightness. A normalized emittance of 4 nm may be measured. Images from discrete cathode tips may be separated in an XDFI image.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A system, comprising:
an electron gun including a field-emitting cathode capable of producing an electron beam with exquisitely small emittance;
an accelerator capable of accelerating the emitted electrons to relativistic energies; and
a focusing assembly capable of focusing the accelerated electrons into a focal spot on a diamond crystal to produce hard X-rays.

2. The system of claim 1, wherein the electron gun comprises a single field-emitting cathode tip.

3. The system of claim 1, wherein the field-emitting cathode is gated.

4. The system of claim 1, wherein the field-emitting cathode includes a diamond pyramid.

5. The system of claim 1, wherein the electron gun comprises an array of field-emitting cathode tips.

6. The system of claim 5, wherein the field-emitting cathode tips of the array are gated.

7. The system of claim 6, wherein the electron gun is configured to control gating of individual field-emitting cathode tips.

8. The system of claim 6, wherein gating of the field-emitting cathode tips is staggered to produce a series of emissions.

9. The system of claim 6, wherein at least a portion of the array of field-emitting tips are gated together.

10. The system of claim 1, wherein the emitted electrons are accelerated to energies from about 3 Mev to about 50 MeV.

11. The system of claim 1, wherein the focal spot has a diameter of about 20 nm to about 100 nm.

12. A method, comprising:
producing an exquisitely small emittance of electrons from a field-emitting cathode;
accelerating the emitted electrons to relativistic energies;
focusing the accelerated electrons into a focal spot on a diamond crystal; and
emitting hard X-rays from the diamond crystal.

13. The method of claim 12, wherein the field-emitting cathode is gated.

14. The method of claim 12, wherein the field-emitting cathode includes a diamond pyramid.

15. The method of claim 12, comprising producing exquisitely small emittances of electrons from an array of field-emitting cathode tips.

16. The method of claim 15, wherein the field-emitting cathode tips of the array are gated.

17. The method of claim 16, wherein gating of the field-emitting cathode tips is staggered.

18. The method of claim 16, wherein at least a portion of the array of field-emitting tips are gated together.

19. The method of claim 12, wherein the emitted electrons are accelerated to energies from about 3 Mev to about 50 MeV.

20. The method of claim 12, wherein the focal spot has a diameter of about 20 nm to about 100 nm.
